(19) United States
(12) Patent Application Publication
(10) Pub. No.: US 2022/0130135 A1
(43) Pub. Date: Apr. 28, 2022

(54) DATA GENERATION METHOD, DATA GENERATION DEVICE, AND PROGRAM

(71) Applicant: NEC Corporation, Minato-ku, Tokyo (JP)

(72) Inventors: Jun PIAO, Tokyo (JP); Soma SHIRAISH, Tokyo (JP); Yasunori BABAZAKI, Tokyo (JP); Hideaki SATO, Tokyo (JP)

(73) Assignee: NEC Corporation, Minato-ku, Tokyo (JP)

(21) Appl. No.: 17/436,695

(22) PCT Filed: Mar. 13, 2019
(86) PCT No.: PCT/JP2019/010323

§ 371 Date: Sep. 7, 2021

(51) Int. Cl. G06V 10/774; G06T 7/70; G06V 10/776; G06V 10/94

(52) U.S. Cl. CPC G06V 10/774; G06T 7/70; G06V 10/776; G06T 2207/20084; G06T 2207/20081; G06T 2207/20092; G06V 2201/07; G06V 10/945

(57) ABSTRACT

The target image acquisition unit 31A acquires a target image subjected to annotation of a correct answer. The first correct answer data acquisition unit 32A acquires first correct answer data indicative of a position including a target object displayed in the target image, a position of a part of the target object or a candidate position of the target object. The second correct answer data generation unit 33A generates, on a basis of an estimator, second correct answer data indicative of an estimated position of the target object from the first correct answer data. Here, the estimator is learned to output the estimated position of the target object from a position including the target object or a position indicating a part of the target object or a candidate position of the target object.

### TECHNICAL FIELD

The present invention relates to a technical field of a data generation method, a data generation device and a program for generating correct answer data necessary for machine learning.

### BACKGROUND ART

An example of the method of presenting the information relating to the correction of the correct answer data which indicates the correct answer used for learning is disclosed in Patent Literature 1. Patent Literature 1 discloses displaying a screen for instructing the deletion or the correction of label for teacher data that is a conversion source of image feature teacher data associated with a target compartment based on the result of the comparison between the image feature teacher data associated with the target compartment and the image feature teacher data associated with the compartment located in the vicinity thereof.

### PRIOR ART DOCUMENTS

### Patent Literature

Patent Literature 1: JP 2015-185149A

### SUMMARY OF THE INVENTION

### Problem to be Solved by the Invention

In the case of requiring workers to accurately perform the annotation of the correct answer in the annotation work, the annotation work needs a lot of time and effort. For example, when a target object is small, the enlargement operation of the image or the like is required, which makes it difficult to efficiently perform the annotation of the correct answer. Although Patent Literature 1 describes generating a new teacher image belonging to the shortage pattern, it is silent on the reduction of the burden of the annotation operation relating to the correct answer.

In view of the above-described issues, it is therefore an example object of the present disclosure to provide a data generation method, a data generation device and a program capable of efficiently generating correct answer data.

### Means for Solving the Problem

In one mode of the data generation method, there is provided a data generation method including: acquiring a target image subjected to annotation of a correct answer; acquiring first correct answer data indicative of a position including a target object displayed in the target image, a position of a part of the target object or a candidate position of the target object; and generating, on a basis of an estimator, second correct answer data indicative of an estimated position of the target object from the first correct answer data, the estimator being learned to output an estimated position of a target object from a position including the target object, a position indicating a part of the target object or a candidate position of the target object.

In one mode of the data generation device, there is provided a data generation device including: a target image acquisition unit configured to acquire a target image subjected to annotation of a correct answer; a first correct answer data acquisition unit configured to acquire first correct answer data indicative of a position including a target object displayed in the target image, a position of a part of the target object or a candidate position of the target object; and a second correct answer data generation unit configured to generate, on a basis of an estimator, second correct answer data indicative of an estimated position of the target object from the first correct answer data, the estimator being learned to output an estimated position of a target object from a position including the target object, a position indicating a part of the target object or a candidate position of the target object.

In one mode of the program, there is provided a program executed by a computer, the program causing the computer to function as: a target image acquisition unit configured to acquire a target image subjected to annotation of a correct answer; a first correct answer data acquisition unit configured to acquire first correct answer data indicative of a position including a target object displayed in the target image, a position of a part of the target object or a candidate position of the target object; and a second correct answer data generation unit configured to generate, on a basis of an estimator, second correct answer data indicative of an estimated position of the target object from the first correct answer data, the estimator being learned to output an estimated position of a target object from a position including the target object, a position indicating a part of the target object or a candidate position of the target object.

### Effect of the Invention

An example advantage according to the present invention is to suitably generate second correct answer data indicating the estimated position of an object from first correct answer data indicating the rough position of the object. Thereby, the burden of generating the first correct answer data is suitably reduced.

### BRIEF DESCRIPTION OF THE DRAWINGS

FIG. 1 illustrates a schematic configuration of training data generation system.

FIG. 2 is a functional block diagram relating to the correct answer data generation process.

FIG. 3 is a functional block diagram relating to the learning process.

FIG. 4A illustrates the position, in a target image, of an object indicated by the first correct answer data when the target object is the head of a person.

FIG. 4B illustrates the position, in the target image, of the target object indicated by the second correct answer data.

FIG. 4C illustrates another example of the position of the target object indicated by the first correct answer data or the fourth correct answer data.

FIG. 5A illustrates the position, in a target image, of an object indicated by the first correct answer data when the target object is multiple feature points of a face.

FIG. 5B illustrates the position, in the target image, of an object indicated by the second correct answer data.

FIG. 6A illustrates a display example of a target image.

FIG. 6B illustrates a binary image included in the first correct answer data.

FIG. 6C illustrates a binary image included in the second correct answer data.

FIG. 7 illustrates a flowchart indicating a processing procedure relating to the correct answer data generation process.

FIG. 8 illustrates a flowchart indicating a processing procedure relating to the learning process.

FIG. 9 illustrates a functional block diagram of a data generation device according to a third modification.

### DESCRIPTION OF EXAMPLE EMBODIMENTS

Hereinafter, an example embodiment of a data generating method, a data generation device, and the program will be described with reference to the drawings. Hereafter, the term “position” of an object in an image includes not only a pixel or a sub-pixel corresponding to a representative point (coordinates) of an object, but also includes a group of pixels corresponding to the entire area of the object.

[Overall Configuration]

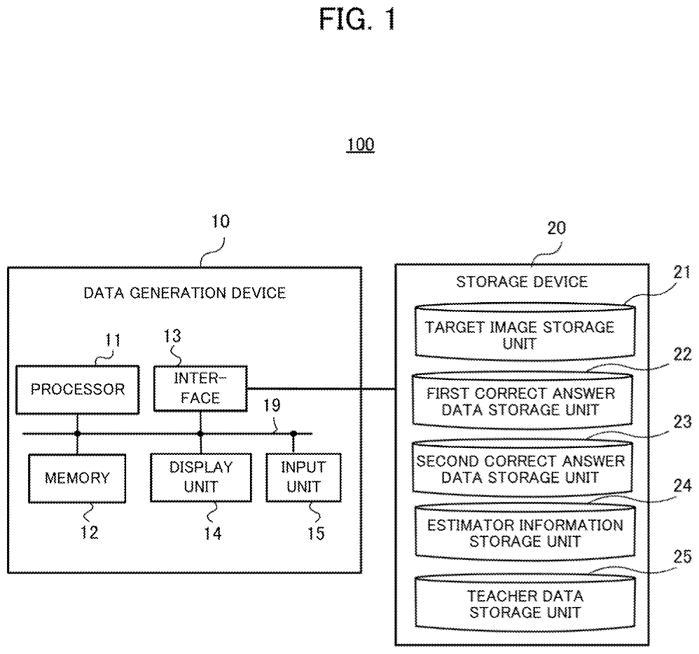

FIG. 1 illustrates a schematic configuration of a training data generation system 100 according to an example embodiment. The training data generation system 100 generates correct answer data with a higher degree of accuracy or precision from correct answer data that is generated through rough annotation operation of the correct answer. The training data generation system 100 includes a data generation device 10 and a storage device 20.

The data generation device 10 performs a process of generating second correct answer data to be stored on the second correct answer data storage unit 23 from first correct answer data stored on the first correct answer data storage unit 22. Details of the first correct answer data and the second correct answer data will be described later.

The storage device 20 includes a target image storage unit 21, a first correct answer data storage unit 22, a second correct answer data storage unit 23, an estimator information storage unit 24 and a teacher data storage unit 25. The storage device 20 may be an external storage device such as a hard disk connected to or built in to the data generation device 10, may be a storage medium such as a flash memory, or may be a server device that performs data communication with the data generation device 10. The storage device 20 may include a plurality of storage devices capable of data communication with the data generation device 10.

The target image storage unit 21 stores images (simply referred to as “target images”) subjected to annotation of the correct answer. Each of the target images includes a target object (also referred to as “target object”) of annotation. The target object is a particular object or a particular part of the object such as an animal (e.g., a person or fish), a plant, a moving object, a feature, an instrument, or a part thereof, such as a person or fish. The target images are suitably used, together with the second correct answer data stored on the second correct answer data storage unit 23, for learning an estimator (inference machine) configured to estimate (infer) the position of the target object from an image.

The first correct answer data storage unit 22 stores the first correct answer data corresponding to each target image stored on the target image storage unit 21. The first correct answer data includes identification information representing the corresponding target image, and classification information indicating the classification (type) of the target object displayed in the corresponding target image, and information indicating the position (also referred to as “target object position”) relating to the target object. The target object position may be one that indicates the coordinates (i.e., point) in the image, or it may be one that indicates the area. Here, the target object position indicated by the first correct answer data is the target object position specified through the rough annotation operation of the correct answer, specifically, the specified position in the target image through the input to a terminal device by an operator performing the annotation operation of the correct answer by use of the terminal device.

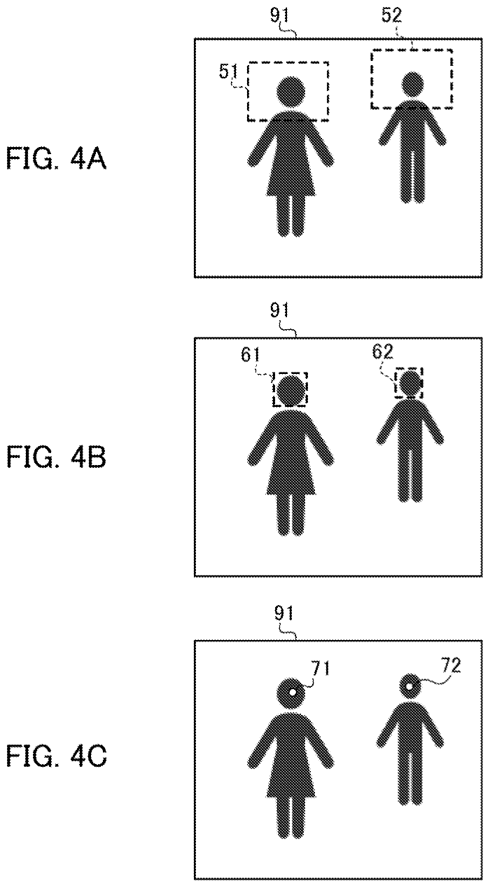

Here, the degree of the accuracy or the precision of the target object position indicated by the first correct answer data is lower than that of the target object position indicated by the second correct answer data to be described later. Specifically, the target object position indicated by the first correct answer data is a position specified in the annotation operation of the correct answer so that it indicates the position including the target object, the position indicating a part of the target object, or a candidate position of the target object (i.e., a candidate of the position of the target object). Specific examples of the target object position indicated by the first correct answer data will be described later with reference to FIGS. 4A to 6C.

When the target object position indicated by the first correct answer data is an area, the first correct answer data may include information indicative of a plurality of coordinates specified in the annotation operation to identify the area. For example, when the target object position of the first correct answer data is a rectangular area, the information relating to the coordinates indicating the vertex positions of the diagonal of the rectangular area specified in the annotation operation is at least included in the first correct answer data. In another example, instead of the information indicative of the coordinates, the first correct answer data may include a binary image indicating the target object position (so-called mask image). The second to fourth correct answer data to be described later may also include information indicative of coordinates or a binary image for indicating the target object position.

The second correct answer data storage unit 23 stores the second correct answer data corresponding to the target images stored on the target image storage unit 21. As with the first correct answer data, the second correct answer data includes: the identification information representing the corresponding target image; the classification information indicating the classification (type) of the target object displayed in the corresponding target image; and the information indicating target object position of the target object. Here, the target object position indicated by the second correct answer data is an estimated position of the target object estimated by inputting the first correct answer data indicating the target object position of the above-mentioned target object to the estimator to be described later. Besides, the target object position indicated by the second correct answer data is more accurate or more precise than the target object position indicated by the first correct answer data. It is noted that, provided that only one type of the target object is present, the first correct answer data and the second correct answer data may not include the classification information.

The estimator information storage unit 24 stores various information necessary to configure the estimator. Here, the estimator is a learning model that is learned to output, when an input image which displays a target object and the target object position thereof in the input image are inputted thereto, an estimation result regarding the target object position in the input image. In this case, the estimator is learned to output the target object position that is more accurate or more precise than the target object position inputted to the estimator. Specifically, the estimator is learned to output an accurate and precise position of a target object when a position (area) including the target object or a position indicating a part of the target object or a candidate position of the target object is inputted. In this case, the learning model used for learning of the estimator may be a learning model based on a neural network, or it may be another type of learning model such as a support vector machine. For example, when the learning model is a neural network such as a convolutional neural network, the estimator information storage unit 24 includes various information necessary to configure the estimator such as, for example, a layer structure, a neuron structure of each layer, the number of filters and filter sizes in each layer, and the weights of each element of each filter.

The teacher data storage unit 25 stores teacher data used for learning the estimator configured by the estimator information stored on the estimator information storage unit 24. Here, the teacher data, which the teacher data storage unit 25 stores, includes a group of images each displaying the target object, and correct answer data (also referred to as “third correct answer data”) corresponding to the group of images. The third correct answer data includes: the correct answer positions of the target objects which appear in each image of the group of images; the classification of each of the target object; and the identification information representing the corresponding image. As will be described later, the third correct answer data is not only used as the teacher data for the estimator described above, but also used to generate correct answer data (referred to as “fourth correct answer data”) indicative of a target object position which is less accurate or less precise than the target object position indicated by the third correct answer data.

Next, a hardware configuration of the data generation device 10 will be described with reference to FIG. 1. The data generation device 10 includes a processor 11, a memory 12, an interface 13, a display unit 14, and an input unit 15 as hardware. The processor 11, the memory 12, the interface 13, the display unit 14, and the input unit 15 are connected via a data bus 19.

The processor 11 executes a predetermined process by executing a program stored on the memory 12. The processor 11 is a processor such as a CPU (Central Processing Unit) or a GPU (Graphics Processing Unit).

The memory 12 includes various memories such as a RAM (Random Access Memory), a ROM (Read Only Memory), and a flash memory. In addition, a program for executing a process relating to learning executed by the data generation device 10 is stored on the memory 12. The memory 12 is used as a work memory and temporarily stores information acquired from the storage device 20. It is noted that the memory 12 may function as a storage device 20. In this case, the memory 12 stores the target image storage unit 21, the first correct answer data storage unit 22, the second correct answer data storage unit 23, the estimator information storage unit 24 and the teacher data storage unit 25. In contrast, the storage device 20 may function as a memory 12 of the data generation device 10.

The interface 13 is a communication interface for wired or wireless transmission and reception of data to and from the storage device 20 under the control of the processor 11, and includes a network adapter and the like. The data generation unit 10 and the storage device 20 may be connected via a cable or the like. In this case, the interface 13 may be a communication interface for performing data communication with the storage device 20 or an interface that conforms to USB, SATA (Serial AT Attachment) or the like for exchanging data with the storage device 20.

The display unit 14 is a display or the like, and display information under the control by the processor 11. The input unit 15 is a mouse, a keyboard, a touch panel, a voice input device, or the like, and supplies input data indicating the detected input to the processor 11.

The hardware configuration of the data generation device 10 is not limited to the configuration shown in FIG. 1. For example, the data generation device 10 may further include a sound output unit such as a speaker. Further, the data generation device 10 may not include at least one of the display unit 14 or the input unit 15.

Further, the data generation device 10 may be configured by a plurality of devices. In this case, each of these devices exchanges information necessary for each device to execute a preliminarily-allocated processing in advance with one another.

[Functional Block]

Next, a description will be given of the functional block of the data generation unit 10. Hereafter, after explaining the correct answer data generation process, the learning process will be described. Here, the correct answer data generation process is a process of generating the second correct answer data from the first correct answer data when the estimator information is already stored on the estimator information storage unit 24. Further, the learning process is a process of generating, by learning, the estimator information to be stored on the estimator information storage unit 24.

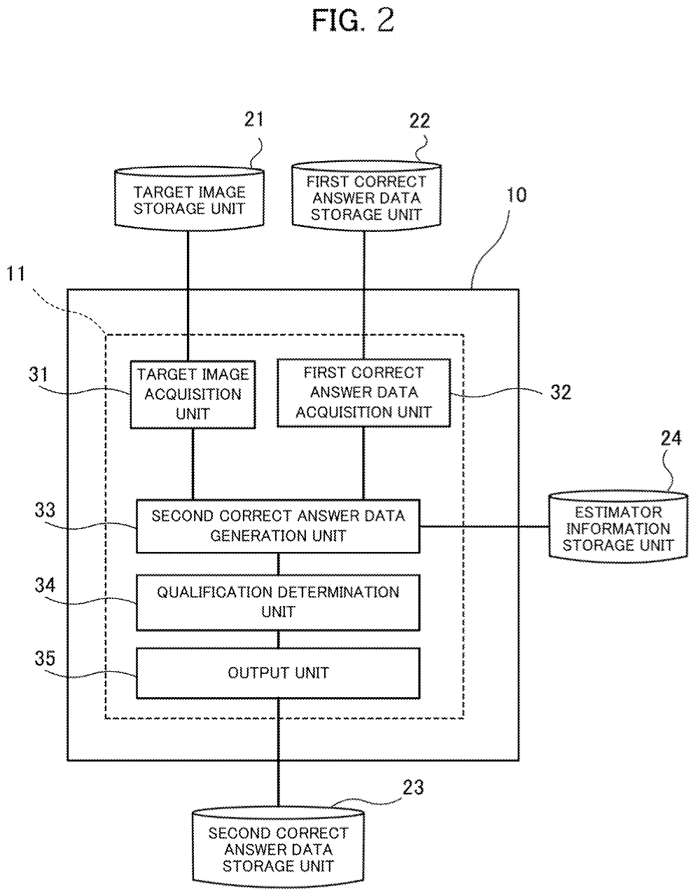

FIG. 2 is a functional block diagram of a data generation device 10 associated with the correct answer data generation process. As shown in FIG. 2, with respect to the correct answer data generation process, the processor 11 of the data generation device includes a target image acquisition unit 31, a first correct answer data acquisition unit 32, a second correct answer data generation unit 33, a qualification determination unit 34, and an output unit 35.

The target image acquisition unit 31 acquires the target image of annotation of the correct answer from the target image storage unit 21. The target image acquisition unit 31 may collectively acquire a plurality of target images from the target image storage unit 21 or may acquire one target image from the target image storage unit 21. In the former case, the data generation device 10 performs subsequent processing in parallel with respect to the acquired target images, or sequentially performs the subsequent processing for each of the acquired target images. Then, the target image acquisition unit 31 supplies the acquired target image to the second correct answer data generation unit 33.

The first correct answer data acquisition unit 32 acquires from the first correct answer data storage unit 22 the first correct answer data corresponding to the target image which the target image acquisition unit 31 acquires. Then, the first correct answer data acquisition unit 32 supplies the acquired first correct answer data to the second correct answer data generation unit 33.

The second correct answer data generation unit 33 generates second correct answer data by inputting, to the estimator, the target image acquired by the target image acquisition unit 31 and the first correct answer data acquired by the first correct answer data acquisition unit 32, wherein the estimator is configured based on the estimator information stored on the estimator information storage unit 24. In this case, the estimator is an arithmetic model (learning model) learned to output the target object position with higher accuracy or precision than the target object position inputted to the estimator. In other words, the estimator is an arithmetic model that is learned to output an estimation result indicating a correct position of the target object when one of: a position (area) including the target object; a position indicating a part of the target object; or a candidate position of the target object is inputted thereto. Therefore, by using such an estimator, the second correct answer data generation unit 33 can suitably generate the second correct answer data indicating the target object position with higher accuracy or precision than the target object position indicated by the first correct answer data. Then, the second correct answer data generation unit 33 supplies the generated second correct answer data and the target image to the qualification determination unit 34.

The qualification determination unit 34 determines the qualification of the second correct answer data, which the second correct answer data generation unit 33 generates, for data indicating the correct answer position of the target object. Then, the qualification determination unit 34 excludes, from the data to be stored on the second correct answer data storage unit 23, the second correct answer data determined that there is no qualification as data indicating the correct answer position of the target object. Specific examples of determining the qualification are described below. The qualification determination unit 34 supplies the second correct answer data determined to have the above-mentioned qualification to the output unit 35.

The output unit 35 outputs the second correct answer data supplied from the qualification determination unit 34. In the present example embodiment, the output unit 35, as an example, stores the second correct answer data supplied from the qualification determination unit 34 on the second correct answer data storage unit 23.

Here, specific examples of the qualification determination by the qualification determination unit 34 will be described.

First, a description will be given of a case where the target object position indicates an area such as a rectangular area. In this case, as a first example, the qualification determination unit 34 determines that the second correct answer data lacks the qualification when the area indicated by the second correct answer data becomes larger than the area indicated by the first correct answer data. The term “area becomes larger” herein may indicate a case that the size of the area is increased or may indicate a case that at least one of the vertical width or horizontal width is increased. Further, as a second example in the case where the target object position indicates the area, the qualification determination unit 34 determines that the second correct answer data lacks the qualification if the overlap ratio between the area indicated by the first correct answer data and the area indicated by the second correct answer data is equal to or less than a predetermined ratio. In this case, the qualification determination unit 34 calculates, for example, IoU (Intersection over Union) as the above-described overlap ratio. The predetermined ratio described above may be 0 (i.e., no overlap at all) or may be a predetermined value greater than 0. Further, as a third example when the target object position indicates the area, the qualification determination unit 34 displays on the display unit 14 the target image explicitly illustrating the area indicated by the first correct answer data and the area indicated by the second correct answer data. Then, the qualification determination unit 34 receives an input which specifies the presence or absence of qualification of the area indicated by the second correct answer data through the input unit 15. In this case, the qualification determination unit 34 determines that the second correct answer data lacks the qualification when an input indicating that the area indicated by the second correct answer data lacks the qualification is detected by the input unit 15.

Next, a description will be given of a case where the target object position indicates coordinates (a point). In this case, as a first example, the qualification determination unit 34 determines that the second correct answer data lacks the qualification if the error (deviation) between the coordinates indicated by the first correct answer data and the coordinates indicated by the second correct answer data is equal to or larger than a predetermined degree. The error in this case may be a squared error or may be an absolute error, or may be the largest error or may be an error based on OKS (Object Keypoint Similarity). As a second example, the qualification determination unit 34 displays on the display unit 14 the target image in which the coordinates indicated by the first correct answer data and the coordinates indicated by the second correct answer data are shown and accept an input by the input unit 15 for specifying the presence or absence of qualification of the coordinates indicated by the second correct answer data. In this case, the qualification determination unit 34 determines that the second correct answer data lacks the qualification if the qualification determination unit 34 detects an input by the input unit 15 indicating that the second correct answer data lacks the qualification.

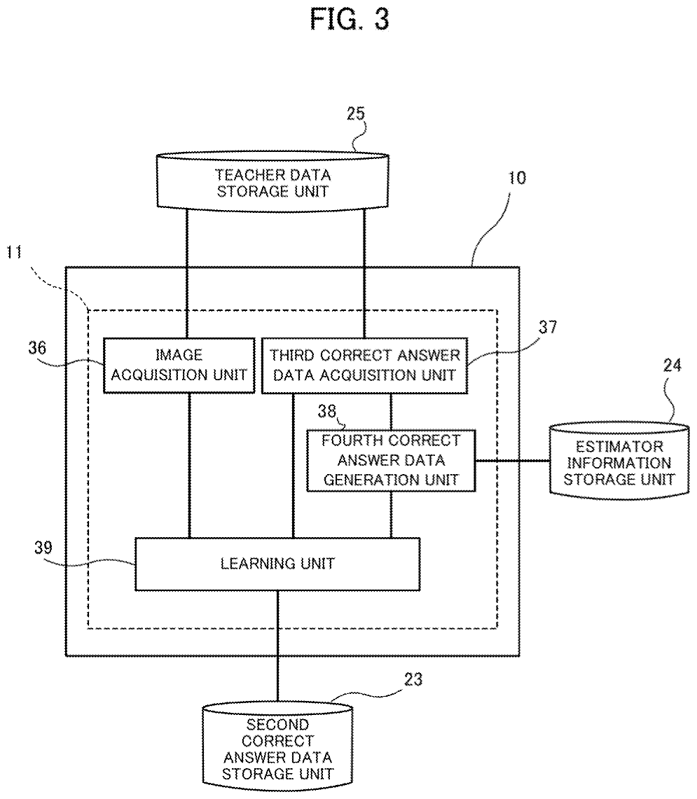

FIG. 3 is a functional block diagram of a data generation device 10 associated with a learning process for generating an estimator.

As shown in FIG. 3, the processor 11 of the data generation device 10 relates to the learning process, and includes an image acquisition unit 36, a third correct answer data acquisition unit 37, a fourth correct answer data generation unit 38, and a learning unit 39.

The image acquisition unit 36 acquires a group of images that are the teacher data used for learning the estimator from the teacher data storage unit 25. Then, the image acquisition unit 36 supplies the acquired group of the images to the learning unit 39.

The third correct answer data acquisition unit 37 acquires from the teacher data storage unit 25 the third correct answer data indicating the target object position of the target object displayed in the group of the images that image acquisition unit 36 acquires. Then, the third correct answer data acquisition unit 37 supplies the acquired third correct answer data to the fourth correct answer data generation unit 38 and the learning unit 39.

The fourth correct answer data generation unit 38 generates a fourth correct answer data from the third correct answer data supplied from the third correct answer data acquisition unit 37. Here, on the basis of the target object position indicated by the third correct answer data, the fourth correct answer data generation unit 38 determines the target object position whose accuracy or precision is lower than the target object position indicated by the third correct answer data. Then, the fourth correct answer data generation unit 38 generates fourth correct answer data indicating the determined target object position.

Specifically, the fourth correct answer data generation unit 38 selects, from the target object position indicated by the third correct answer data, a position corresponding to any one of: the position including the target object; the position indicating a part of the target object; or a candidate position of the target object. Then, the fourth correct answer data generation unit 38 generates a fourth correct answer data indicating the selected position as the target object position. More specifically, the fourth correct answer data generation unit 38 selects, from the target object position indicated by the third correct answer data, a position corresponding to any one of: a randomly selected position as the position including the target object; a randomly selected position as the position indicating a part of the target object; or a randomly selected position as a candidate position of the target object. For example, in a case of generating the fourth correct answer data indicating the position including the target object from the target object position indicated by the third correct answer data, the fourth correct answer data generation unit 38 generates the fourth correct answer data indicative of the target object position after enlarging or shifting the target object position indicated by the third correct answer data. In this case, the degree of the enlargement, the direction of the shift, and the shift distance are determined at random. Then, the fourth correct answer data generation unit 38 supplies the generated fourth correct answer data to the learning unit 39.

The learning unit 39 trains a learning model to generate an estimator based on: the group of the images supplied from the image acquisition unit 36; the third correct answer data supplied from the third correct answer data acquisition unit 37; and the fourth correct answer data supplied by the fourth correct answer data generation unit 38. Specifically, the above estimator is a learning model learned to output, when each of the grouped images described above and the target object position indicated by the fourth correct answer data is inputted thereto, the target object position indicated by the third correct answer data. Therefore, the learning unit 39 trains the above-mentioned learning model by regarding a set of the image group supplied from the image acquisition unit 36 and the target object position indicated by the fourth correct answer data corresponding thereto as an input sample, and regarding the target object position indicated by the third correct answer data as a correct answer data sample. Then, the learning unit 39 stores the estimator information relating to the estimator corresponding to the learned learning model on the estimator information storage unit 24.

[Concrete Example of Correct Answer Data]

Next, a specific example of the target object position indicated by the first to fourth correct answer data. As described below, the target object position indicated by the first correct answer data and the fourth correct answer data is determined to be: the position including the target object; the position indicating a part of the target object; or a candidate position of the target object. Further, the target object position indicated by the second correct answer data and the third correct answer data is determined so as to indicate the correct answer position of the target object.

First, the case where the first correct answer data and the fourth correct answer data indicates the position including the target object will be described with reference to FIG. 4A and FIG. 4B.

FIG. 4A illustrates, on the target image 91, the target object position 51 and the target object position 52 which the first correct answer data indicates when the target object is the head of a person. FIG. 4B illustrates, on the target image 91, the target object position 61 and the target object position 62 indicated by the second correct answer data.

In the example of FIG. 4A, the target object positions 51 and 52 indicated by the first correct answer data is an area roughly (by low accuracy) specified to include at least the entire display area of the target object, respectively. On the other hand, the target object positions 61 and 62 indicated by the second correct answer data, as shown in FIG. 4 (B), illustrates the area of the head of the target object with higher degree of accuracy than the target object positions 51 and 52 indicated by the first correct answer data. Thus, the second correct answer data generation unit 33 generates the second correct answer data indicating the target object position with an accuracy or a precision higher than that of the first correct answer data.

Further, the target object positions 61 and 62 shown in FIG. 4B can be regarded as an example of the target object position indicated by the third correct answer data, and the target object positions 51 and 52 shown in FIG. 4A can also be regarded as an example of the target object position indicated by the fourth correct answer data. In this case, the fourth correct answer data generation unit 38, the target object position 61, 62 indicated by the third correct answer data is enlarged by a predetermined magnification, and generates a fourth correct answer data indicating the target object position 51, 52 moved in a predetermined direction by a predetermined distance. The predetermined magnification and a predetermined distance described above, for example, is determined randomly from a predetermined value range, the predetermined direction is determined randomly from all directions.

Next, a description will be given of a case where the target object position indicated by the first correct answer data and the fourth correct answer data is a position indicating a part of the target object with reference to FIG. 4B and FIG. 4C.

FIG. 4C illustrates an example of the target object position indicated by the first correct answer data or the fourth correct answer data. The target object positions 71 and 72 shown in FIG. 4C shows a part of the area or coordinates in the display area of the target object (human head) displayed on the target image. In this case, for example, when the first correct answer data indicates the target object positions 71 and 72 in FIG. 4C, the second correct answer data generation unit 33 generates, from the target object positions 71 and 72 representing a portion of the head, a second correct answer data indicative of the target object positions 61 and 62 that are the position of the entire head. Further, when the third correct answer data indicates the target object positions 61 and 62 in FIG. 4B, the fourth correct answer data generation unit 38 determines, from the display area of the entire head indicated by the target object positions 61 and 62, the target object positions 71 and 72 that is a randomly-selected portion of the display area. Then, the fourth correct answer data generation unit 38 generates fourth correct answer data indicating the selected target object positions 71 and 72.

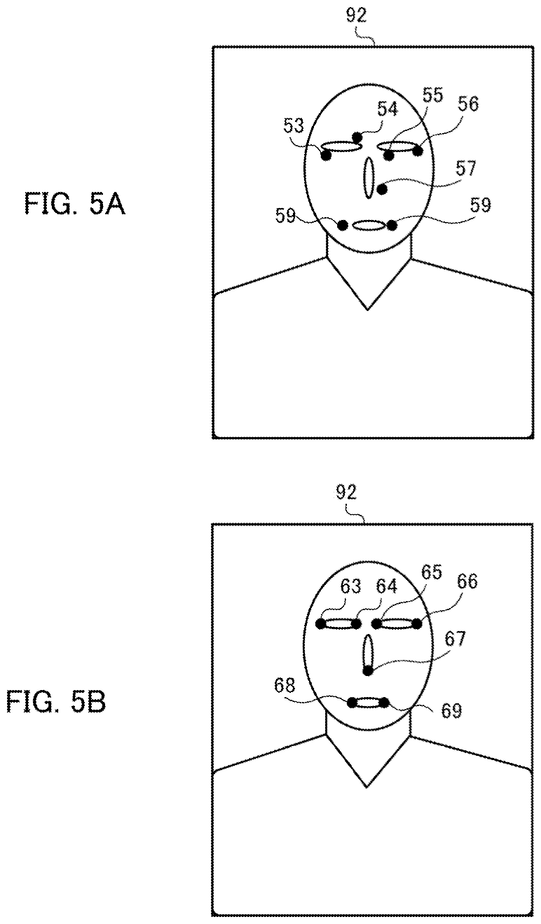

Next, a description will be given of a case where the target object position indicated by the first correct answer data or the fourth correct answer data is a candidate position of the target object with reference to FIGS. 5A and 5B.

FIG. 5A illustrates the target object positions 53 to 59 indicated by the first correct answer data on the target image 92 when the target object is a plurality of feature points (both ends of both eyes, a nose, and both ends of a mouth) of the face. FIG. 5B illustrates the target object positions 63 to 69 indicated by the second correct answer data on the target image 92.

In the example of FIG. 5A, the target object positions 53 to 59 indicated by the first correct answer data are roughly (by low accuracy) specified so as to be the candidate positions of the feature points that are the target objects, respectively. Each of the target object positions 53 to 59 indicates an area or coordinates in the vicinity of a display area of each target object (here, feature points of a face) displayed in the target image 92.

On the other hand, the target object positions 63 to 69 indicated by the second correct answer data, as shown in FIG. 5B, indicates the position of each feature point with an accuracy (precision) higher than that of the target object positions 53 to 59 indicated by the first correct answer data. Thus, the second correct answer data generation unit 33 generates a second correct answer data indicating the target object position with an accuracy (precision) higher than that of the first correct answer data.

Further, the target object positions 63 to 69 shown in FIG. 5B can be regarded as an example of the target object position indicated by the third correct answer data, and the target object positions 53 to 59 shown in FIG. 5A can also be regarded as an example of the target object position indicated by the fourth correct answer data. In this case, the fourth correct answer data generation unit 38 generates the fourth correct answer data indicating the target object positions 53 to 59 that are the target object positions 63 to 69 indicated by the third correct answer data respectively moved by a predetermined distance in a predetermined direction. For example, the predetermined distance described above is determined randomly from a predetermined value range and the predetermined direction is determined randomly from all directions.

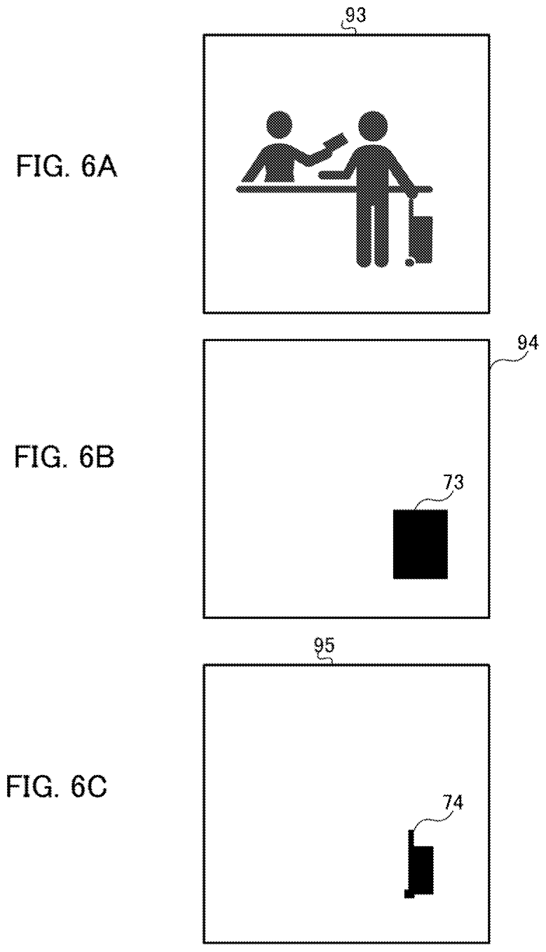

Next, a case where the first to fourth correct answer data has a binary image indicating the target object position will be described with reference to FIGS. 6A to 6C.

FIG. 6A illustrates a display example of a target image 93. FIG. 6B illustrates a binary image 94 included in the first correct answer data. FIG. 6C is a binary image 95 included in the second correct answer data. The binary images 94 and 95 are mask images that indicate the positions of the loads that are the target objects, respectively. Here, as an example, the binary images 94 and 95 display pixels indicating the position of the target object in black.

In this case, the binary image 94 of the first correct answer data roughly (i.e., by low accuracy) indicates an area including at least the entire display area of the load that is the target object. On the other hand, as shown in FIG. 6C, the binary image 95 of the second correct answer data indicates the area of the load that is the target object with a degree of accuracy (precision) higher than that of the target object position indicated by the binary image 94 of the first correct answer data. In this way, the second correct answer data generation unit 33 generates the second correct answer data including a binary image 95 indicative of the target object position which is more accurate or precise than that of the binary image 94 of the first correct answer data.

Further, the binary image 95 shown in FIG. 6C can be regarded as an example of information of the target object position included in the third correct answer data, and the binary image 94 shown in FIG. 6B can also be regarded as an example of information of the target object position included in the fourth correct answer data. In this case, for example, the fourth correct answer data generation unit 38 generates the fourth correct answer data including the binary image 94 showing a rectangular area after enlarging (and shifting) the minimum rectangular area including the target object position indicated by the binary image 95 included in the third correct answer data. In this case, the degree of the enlargement, the direction of the shift, and the distance of the shift are selected at random.

[Processing Flow]

Next, each processing flow of correct answer data generation process and the learning process will be described.

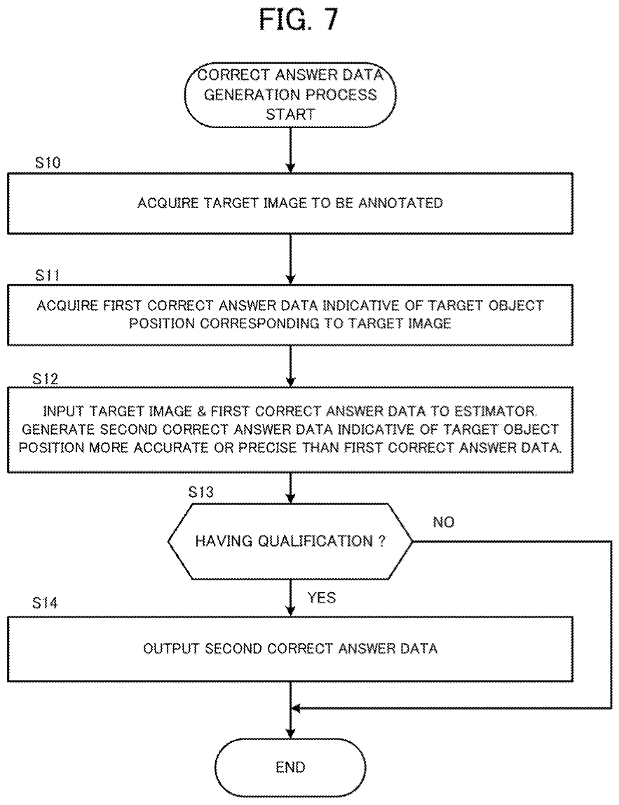

FIG. 7 is a flowchart showing a processing procedure relating to the correct answer data generation process. For example, the data generation device 10 repeatedly execute the processing of the flowchart shown in FIG. 7 for each target image stored in the target image storage unit 21.

First, the target image acquisition unit 31 acquires a target image to be annotated from the target image storage unit 21 (step S10). Then, the first correct answer data acquisition unit 32 acquires the first correct answer data indicating the target object position with respect to the target image acquired at step S10 (step S11).

Then, the second correct answer data generation unit 33 inputs the target image and the first correct answer data to the estimator configured by the estimator information included in the estimator information storage unit 24 and generates the second correct answer data indicative of the target object position which is more accurate or precise than that of the first correct answer data (step S12).

Next, the qualification determination unit 34 determines whether or not the second correct answer data generated at step S12 has the qualification as data indicating the correct answer position of the target object (step S13). Then, if the second correct answer data has the above qualification (step S13; Yes), the output unit 35 outputs the second correct answer data (step S14). Specifically, the output unit 35 stores the second correct answer data on the second correct answer data storage unit 23. Thereby, the data generation device 10 can suitably generate the second correct answer data indicating the target object position with a degree of accuracy or precision higher than that of the first correct answer data. This second correct answer data, together with the corresponding target image, is suitably used for training of the learning model.

On the other hand, if the second correct answer data does not have the qualification (step S13; No), the output unit 35 terminates the processing of the flowchart without outputting the second correct answer data. Thereby, the data generation device 10 can suitably prevent storing the second correct answer data likely to be improper correct answer data on the second correct answer data storage unit 23. Thus, it is possible to suitably suppress the use of improper correct answer data as training data.

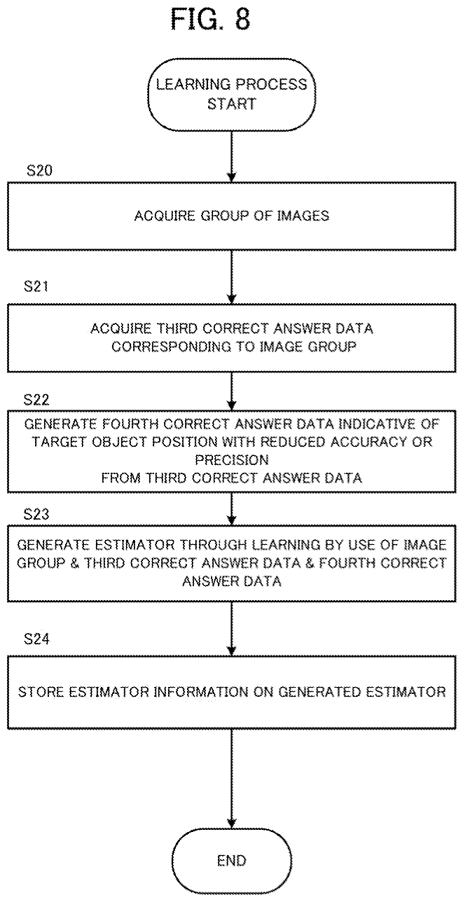

FIG. 8 is a flowchart showing the procedure of learning process related to the estimator.

First, the image acquisition unit 36 acquires a group of images from the teacher data storage unit 25 (step S20). Further, the third correct answer data acquisition unit 37 acquires the third correct answer data accurately and precisely indicating the position of the target object displayed in each image of the image group acquired at step S20 from the teacher data storage unit 25 (step S21).

Next, the fourth correct answer data generation unit 38 generates, from the third correct answer data obtained at step S21, a fourth correct answer data indicating the target object position with reduced accuracy or reduced precision (step S22). Specifically, the fourth correct answer data generation unit 38 determines a position corresponding to any one of: the position including the target object; the position indicating a part of the target object; or the candidate positions of the target object and generates the fourth correct answer data indicating the determined position as the target object position.

Then, the learning unit 39 generates an estimator for use at step S12 of FIG. 7 through the learning using the image group acquired at step S20, the third correct answer data acquired at step S21 and the fourth correct answer data acquired at step S22 (step S23). Specifically, the learning unit 39 performs the training of the learning model by regarding the set of the group of the images and the target object position indicated by the fourth correct answer data corresponding thereto as an input sample and regarding the target object position indicated by the third correct answer data as a sample of the correct answer data. Then, the learning unit 39 stores the estimator information indicative of the generated estimator on the estimator information storage unit 24 (Step S24).

Here, a supplementary description will be given of the effect according to the present example embodiment.

Generally, the time and labor are required for the annotation work of the correct answer when the worker is requested to carry out the precise annotation work. For example, when the target object is small, the enlargement operation of the image or the like is required, which makes it difficult to efficiently perform the annotation. In addition, since the criteria adopted at the annotation of the correct answer depend on workers. Thus, when the annotation of the correct answer is performed by multiple workers, the quality of the correct answer data obtained does not become uniform even when each worker performs the annotation of the correct answer over time.

In view of the above, the data generation device 10 according to the present example embodiment suitably generates, from the first correct answer data based on the annotation of the correct answer performed roughly in the operation, a second correct answer data having a uniform quality. Thus, it is possible to suitably reduce the time and labor of the annotation work of the correct answer while generating the second correct answer data with uniform quality even when the annotation is performed by a plurality of workers.

[Modification]

Next, a description will be given of preferred modifications to the example embodiment described above. The modifications described below may be applied to the example embodiments described above in arbitrary combination.

(First Modification)

The data generation device 10 may perform only the second correct answer data generation process while the second correct answer data generation process and the learning process are described above.

In this case, the estimator information which a device other than the data generation device 10 generate in advance is stored in the estimator information storage unit 24, and the data generation device 10 executes the second correct answer data generation process with reference to the estimator information storage unit 24. Thereby, it is possible generate a second correct answer data having a uniform quality from the first correct answer data based on the annotation of the correct answer performed roughly in the annotation operation.

(Second Modification)

Data generation device 10 may receive the target image and the first correct answer data from a terminal device for performing the annotation work of the correct answer, instead of acquiring the target image and the first correct answer data from the storage device 20.

In this case, the data generation device 10 performs data communication via a network or the like with one or more terminal devices for generating the first correct answer data by accepting a user input through the annotation work of the correct answer. Then, when receiving the combination of the target image and the first correct answer data from the terminal devices described above, the data generation device 10 executes the process at step S12 and subsequent process in the correct answer data generation process shown in FIG. 7. Even in this way, it is possible to suitably generate the second correct answer data having a uniform quality from the first correct answer data based on the annotation performed roughly in the annotation operation.

(Third Modification)

The data generation device 10 may not have a function corresponding to the qualification determination unit 34 and the output unit 35 shown in FIG. 2.

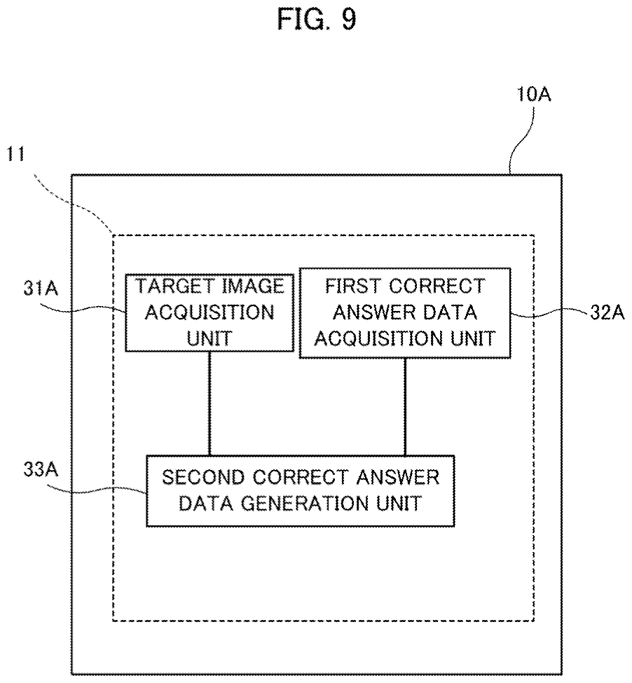

FIG. 9 is a functional block diagram of a data-generation device 10A according to the third modification. As illustrated in FIG. 9, the processor 11 of the data generation device 10A includes a target image acquisition unit 31A, a first correct answer data acquisition unit 32A, and a second correct answer data generation unit 33A.

In this case, the target image acquisition unit 31A acquires a target image subjected to annotation of a correct answer. The first correct answer data acquisition unit 32A acquires first correct answer data indicative of a position including a target object displayed in the target image, a position of a part of the target object or a candidate position of the target object. The second correct answer data generation unit 33A generates, on a basis of an estimator, second correct answer data indicative of an estimated position of the target object from the first correct answer data. Here, the estimator is learned to output the estimated position of the target object from a position including the target object or a position indicating a part of the target object or a candidate position of the target object. Thereby, the data generation device 10A can suitably generate a second correct answer data having a uniform quality from the first correct answer data based on the annotation performed roughly in the annotation operation.

The whole or a part of the example embodiments described above (including modifications, the same applies hereinafter) can be described as, but not limited to, the following Supplementary Notes.

[Supplementary Note 1]

A data generation method comprising:

acquiring a target image subjected to annotation of a correct answer;

acquiring first correct answer data indicative of
a position including a target object displayed in the target image,
a position of a part of the target object or
a candidate position of the target object; and

generating, on a basis of an estimator, second correct answer data indicative of an estimated position of the target object from the first correct answer data, the estimator being learned to output an estimated position of a target object from a position including the target object, a position indicating a part of the target object or a candidate position of the target object.

[Supplementary Note 2]

The data generation method according to Supplementary Note 1,

wherein the first correct answer data indicates a position specified in the target image.

[Supplementary Note 3]

The data generation method according to Supplementary Note 1 or 2,

wherein the position including the object is an area specified to include at least an entire display area of the target object displayed on the target image.

[Supplementary Note 4]

The data generation method according to any one of Supplementary Notes 1 to 3,

wherein the position of the part of the object indicates a part of an area or coordinates specified in a display area of the target object displayed on the target image.

[Supplementary Note 5]

5. The data generation method according to any one of Supplementary Notes 1 to 4,

wherein the candidate position indicates an area or coordinates in or around a display area of the target object displayed on the target image.

[Supplementary Note 6]

6. The data generation method according to any one of Supplementary Notes 1 to 5, further comprising

determining whether or not the estimated position indicated by the second correct answer data has qualification as a correct answer position of the target object.

[Supplementary Note 7]

7. The data generation method according to Supplementary Note 6, further comprising

storing the second correct answer data determined to have the qualification on a storage unit as training data used for learning.

[Supplementary Note 8]

8. The data generation method according to any one of Supplementary Notes 1 to 7, further comprising:

acquiring a group of images;

acquiring the third correct answer data indicative of a position of a target object displayed on each image of the group of the images;

generating, from the third correct answer data, fourth correct answer data indicative of
a position including the target object,
a position of a part of the target object or
a candidate position of the target position

learning the estimator based on the group of the images, the third correct answer data and the fourth correct answer data.

[Supplementary Note 9]

9. The data generation method according to Supplementary Note 8,

wherein the fourth correct answer data indicative of any one of
a position randomly determined as the position including the target object,
a position randomly determined as the position of the part of the target object, and
a position randomly determined as the candidate position of the target object.

[Supplementary Note 10]

A data generation device comprising:

a target image acquisition unit configured to acquire a target image subjected to annotation of a correct answer;

a first correct answer data acquisition unit configured to acquire first correct answer data indicative of
a position including a target object displayed in the target image,
a position of a part of the target object or
a candidate position of the target object; and

a second correct answer data generation unit configured to generate, on a basis of an estimator, second correct answer data indicative of an estimated position of the target object from the first correct answer data, the estimator being learned to output an estimated position of a target object from a position including the target object, a position indicating a part of the target object or a candidate position of the target object.

[Supplementary Note 11]

A program executed by a computer, the program causing the computer to function as:

a target image acquisition unit configured to acquire a target image subjected to annotation of a correct answer;

a first correct answer data acquisition unit configured to acquire first correct answer data indicative of
a position including a target object displayed in the target image,
a position of a part of the target object or
a candidate position of the target object; and

a second correct answer data generation unit configured to generate, on a basis of an estimator, second correct answer data indicative of an estimated position of the target object from the first correct answer data, the estimator being learned to output an estimated position of a target object from a position including the target object, a position indicating a part of the target object or a candidate position of the target object.

While the invention has been particularly shown and described with reference to example embodiments thereof, the invention is not limited to these embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent Literatures mentioned in this specification are incorporated by reference in its entirety.

### DESCRIPTION OF REFERENCE NUMERALS

10, 10A Data generation device
11 Processor
12 Memory
13 Interface
14 Display unit
15 Input unit
20 Storage device
21 Target image storage unit
22 First correct answer data storage unit
23 Second correct answer data storage unit
24 Estimator information storage unit
25 Teacher data storage unit
100 Training data generation system

What is claimed is:

1. A data generation method comprising:
acquiring a target image subjected to annotation of a correct answer;
acquiring first correct answer data indicative of
a position including a target object displayed in the target image,
a position of a part of the target object or
a candidate position of the target object; and
generating, on a basis of an estimator, second correct answer data indicative of an estimated position of the target object from the first correct answer data, the estimator being learned to output an estimated position of a target object from a position including the target object, a position indicating a part of the target object or a candidate position of the target object.

2. The data generation method according to claim 1,
wherein the first correct answer data indicates a position specified in the target image.

3. The data generation method according to claim 1,
wherein the position including the object is an area specified to include at least an entire display area of the target object displayed on the target image.

4. The data generation method according to claim 1,
wherein the position of the part of the object indicates a part of an area or coordinates specified in a display area of the target object displayed on the target image.

5. The data generation method according to claim 1,
wherein the candidate position indicates an area or coordinates in or around a display area of the target object displayed on the target image.

6. The data generation method according to claim 1, further comprising
determining whether or not the estimated position indicated by the second correct answer data has qualification as a correct answer position of the target object.

7. The data generation method according to claim 6, further comprising
storing the second correct answer data determined to have the qualification on a storage unit as training data used for learning.

8. The data generation method according to claim 1, further comprising:
acquiring a group of images;
acquiring the third correct answer data indicative of a position of a target object displayed on each image of the group of the images;
generating, from the third correct answer data, fourth correct answer data indicative of
a position including the target object,
a position of a part of the target object or
a candidate position of the target position
learning the estimator based on the group of the images, the third correct answer data and the fourth correct answer data.

9. The data generation method according to claim 8,
wherein the fourth correct answer data indicative of any one of
a position randomly determined as the position including the target object,
a position randomly determined as the position of the part of the target object, and
a position randomly determined as the candidate position of the target object.

10. A data generation device
comprising a processor configured to:
acquire a target image subjected to annotation of a correct answer;
acquire first correct answer data indicative of
a position including a target object displayed in the target image,
a position of a part of the target object or
a candidate position of the target object; and
generate, on a basis of an estimator, second correct answer data indicative of an estimated position of the target object from the first correct answer data, the estimator being learned to output an estimated position of a target object from a position including the target object, a position indicating a part of the target object or a candidate position of the target object.

11. A non-transitory computer readable medium including a program executed by a computer, the program causing the computer to:
acquire a target image subjected to annotation of a correct answer;
acquire first correct answer data indicative of
a position including a target object displayed in the target image,
a position of a part of the target object or
a candidate position of the target object; and
generate, on a basis of an estimator, second correct answer data indicative of an estimated position of the target object from the first correct answer data, the estimator being learned to output an estimated position of a target object from a position including the target object, a position indicating a part of the target object or a candidate position of the target object.

12. The data generation device according to claim 10,
wherein the first correct answer data indicates a position specified in the target image.

13. The data generation device according to claim 10,
wherein the position including the object is an area specified to include at least an entire display area of the target object displayed on the target image.

14. The data generation device according to claim 10,
wherein the position of the part of the object indicates a part of an area or coordinates specified in a display area of the target object displayed on the target image.

15. The data generation device according to claim 10,
wherein the candidate position indicates an area or coordinates in or around a display area of the target object displayed on the target image.

16. The data generation device according to claim 10,
wherein the processor is further configured to determine whether or not the estimated position indicated by the second correct answer data has qualification as a correct answer position of the target object.

17. The data generation device according to claim 16,
wherein the processor is further configured to store the second correct answer data determined to have the qualification on a storage unit as training data used for learning.

18. The data generation device according to claim 10,
wherein the processor is further configured to:
acquire a group of images;
acquire the third correct answer data indicative of a position of a target object displayed on each image of the group of the images;
generate, from the third correct answer data, fourth correct answer data indicative of
a position including the target object,
a position of a part of the target object or
a candidate position of the target position
learn the estimator based on the group of the images, the third correct answer data and the fourth correct answer data.

19. The data generation device according to claim 18,
wherein the fourth correct answer data indicative of any one of
a position randomly determined as the position including the target object,
a position randomly determined as the position of the part of the target object, and
a position randomly determined as the candidate position of the target object.
